(19) United States
(12) Patent Application Publication
(10) Pub. No.: US 2008/0171208 A1
(43) Pub. Date: Jul. 17, 2008

(54) Adhesives

(76) Inventors: Jorg Buchner, Bergisch Gladbach (DE); Christoph Gurtler, Koln (DE); Raul Pires, Shanghai (CN); Wolfgang Henning, Kurten (DE); Wolfgang Arndt, Dormagen (DE)

Correspondence Address: CONNOLLY BOVE LODGE & HUTZ, LLP, P O BOX 2207, WILMINGTON, DE, 19899, US

(21) Appl. No.: 12/001,158

(22) Filed: Dec. 10, 2007

(30) Foreign Application Priority Data
Dec. 12, 2006 (DE) 102006058527.5

(51) Int. Cl. C09J 175/04; C08G 18/02; B32B 27/40

(52) U.S. Cl. 428/423.1; 524/589; 427/208.2

(57) ABSTRACT

The invention relates to adhesives based on aqueous dispersions and surface-deactivated isocyanate particles and to latently reactive coatings, films and powders produced from such dispersions. The adhesives are prepared from aqueous compositions containing a) dispersed polymers with isocyanate-reactive groups; b) at least one dispersed surface-deactivated aliphatic solid polyisocyanate with a softening temperature of ≧40° C.; c) one or more compounds of elements from subgroups 5 and 6 of the periodic system of elements, in which the particular element has an oxidation number of at least +4 and, d) optionally further additives and auxiliaries.

### CROSS-REFERENCE TO RELATED APPLICATION

This application claims priority under 35 U.S.C. §119(a-d) to German application No. 10 2006 058527.5, filed Dec. 12, 2006.

### FIELD OF THE INVENTION

The invention relates to adhesives based on aqueous dispersions and surface-deactivated isocyanate particles and to latently reactive coatings, films and powders produced from such dispersions.

### BACKGROUND OF THE INVENTION

Polyurethane dispersion polymers having linear polymer chains which crystallise at temperatures below 100° C. are used, inter alia, for heat-activated adhesive bonding of thermally sensitive substrates. However, in the case of single component processing, i.e. without the addition of a crosslinking agent, only low heat resistance values which correlate with the decrystallisation temperature or softening temperature of the polymer are obtained. Moreover, in the case of single component processing, hydrolysis resistance is inadequate for many applications. It is for this reason that aqueous dispersion polymers are conventionally processed together with liquid, hydrophilically modified polyisocyanates. However, the gain in terms of improved properties is obtained at the cost of the greater technical complexity of two-component processing. The two-component mixture must be produced immediately before processing of the dispersion. Two-component processing is moreover error-prone with regard to addition of the correct quantity of isocyanate component and homogeneous incorporation of the isocyanate component.

Depending on the nature of the polymer dispersion or of the isocyanate component, the pot life of the two-component mixture amounts to 1-12 hours. Furthermore, the dried adhesive layers must be processed within approx. 1-12 hours, due to the ongoing crosslinking reaction by the isocyanate groups, and the polymer can no longer be processed under conventional heat-induced adhesive bonding conditions.

This gives rise to a further disadvantage of this procedure: the application and curing steps, i.e. application of the adhesive dispersion and heat-induced crosslinking, cannot proceed separately at different times and places. However, from an economic standpoint, such separation would be convenient and desirable for many applications

For this reason, greater use has in recent years been made of dispersion formulations comprising solid finely divided isocyanates. These “latently reactive” dispersion adhesives consist of at least one dispersion of isocyanate-reactive polymers and solid isocyanate particles. Aqueous preparations of isocyanate-reactive polymer dispersions comprising finely dispersed, surface-deactivated, oligomeric solid isocyanates containing uretidione groups and the use thereof as latently reactive binders for coatings and adhesives have been known for some years.

Surface-deactivated isocyanate particles are understood to be solid isocyanates in which 0.1-25 equivalent percent, preferably 0.5-8 equivalent percent, of the total number of isocyanate groups present in the isocyanate particles have been reacted with a deactivating agent. The isocyanate particles can for example be deactivated by the deactivating agents described in EP-A 0 204 970, U.S. Pat. No. 4,595,445 and DE 10140206. Surface-deactivated isocyanate particles differ fundamentally from blocked isocyanates. In surface-deactivated isocyanate particles preferably 92-99.5 equivalent percent of the isocyanate groups are free. In blocked isocyanates, on the other hand, all of the isocyanate groups are reacted with a blocking agent. For the crosslinking reaction the isocyanate groups of blocked isocyanates first of all have to be deblocked for example by the back-cleavage of the blocking agent. In surface-deactivated isocyanate particles the deblocking reaction of the isocyanate groups is not necessary.

EP-A 0 204 970 describes a method for producing stable dispersions of finely divided polyisocyanates by treatment of the polyisocyanates in a liquid with stabilisers and exposure to elevated shear forces or grinding. Di- and polyisocyanates which are suitable for this purpose are those having a melting point of above 10° C., preferably above 40° C. The described dispersions are used as crosslinking agents.

EP-A 1 172 390 discloses storage-stable isocyanate dispersions consisting of deactivated isocyanates and isocyanate-reactive polymers which, after removal of the water, crosslink at temperatures of between 5° C. and 40° C. The aqueous dispersion preparations are distinguished by good storage stability.

The disadvantage of the procedure described in this publication is that the largely dry coatings, films or powders are not stable in storage. The crosslinking reaction begins with the drying of the layers. The desired ability to carry out the steps of application/drying of the dispersion layer and joining of the bonds at different times and places cannot be achieved with this procedure.

EP-A 1 134 245 describes storage-stable preparations of finely divided di- and polyisocyanate powders which may be directly incorporated without surface-deactivation into the aqueous isocyanate-reactive polymer dispersions. In these formulations, the crosslinking reaction is initiated by heating the dried layer to a temperature of at least 65° C.

The disadvantage of the procedure described in this document is the fact that storage-stable, latently reactive coatings, films or powders cannot be obtained from these formulations either. The desired ability to carry out the steps of application/drying of the dispersion layer and joining of the bonds at different times and places cannot be achieved with this procedure either.

EP-A 0 922 720 discloses the use of aqueous dispersions which contain at least one surface-deactivated polyisocyanate and at least one isocyanate-reactive polymer for producing latently reactive layers or powders which are storage-stable at room temperature and may be caused to crosslink by heating.

Polyisocyanates which may be used are any aliphatic, cycloaliphatic, heterocyclic or aromatic isocyanates which exhibit a melting point of above 40° C. The stability of the prior coatings, films or powders and their rate of reaction on heat-induced crosslinking may be influenced by the nature of the isocyanate, the quantity of the surface stabiliser, the solubility parameters of the dispersion polymer and by catalysts.

The catalysts mentioned are the typical polyurethane catalysts such as tin, iron, lead, cobalt, bismuth, antimony and zinc compounds or mixtures thereof, alkyl mercaptide compounds of dibutyltin and tertiary amines.

Storage-stable, latently reactive coatings, films and powders are thus possible according to EP-A 0 922 720. The desired ability to carry out application of the adhesive and the joining process at different times and places is thus in principle possible.

However, if aromatic solid-isocyanates are used as the solid isocyanate, yellowing of the adhesive layer then occurs with increasing age of the adhesive joint under the action of the long-wavelength UV fraction of sunlight (Kunststoff Handbuch 7, 605-608 (1993)).

This yellowing is not wanted in joints in which the adhesive layer is visible (for example paper/film adhesive bonds for security documents), or in which the adhesive layer is not completely covered by the substrates (for example sole adhesive bonds in sports shoe manufacture).

Since aliphatic isocyanates or polyurethanes based on aliphatic isocyanates do not absorb the short wavelength UV fraction of sunlight, these polyurethanes are in principle protected from yellowing. In those applications in which non-discolouring, latently reactive coatings, latently reactive films or latently reactive powders are of importance, it is therefore particularly advantageous to use surface-deactivated aliphatic solid isocyanates.

One disadvantage of aliphatic isocyanates is, however, their known lower reactivity in comparison with aromatically attached isocyanate groups. This is known, for example, from Ullmann's Encyclopedia of Industrial Chemistry, Sixth Edition, vol. 18, page 609, Wiley-VCH Verlag, 2002, Isocyanates, Organic. For this reason, to date it has not yet been possible to establish any applications of latently reactive coatings, films or powders based on deactivated aliphatic solid isocyanates. The relative reactivity of the free isocyanate group of the isocyanurate from isophorone diisocyanate (IPDI) towards OH groups is accordingly lower by a factor of approx. 50 than the reactivity of the free isocyanate groups of the aromatic compound 1-methyl-2,4-phenylene diisocyanate (TDI dimer) towards OH groups.

Latently reactive coatings, films or powders according to EP-A 0 922 720 which contain a deactivated aliphatic solid isocyanate as the crosslinking component, require, in order to crosslink the isocyanate-reactive polymer, either
a) very long exposure to elevated temperatures in order to carry out the crosslinking reaction to such an extent that an adequate crosslink density is obtained, or
b) a catalyst which accelerates the reaction between the aliphatic isocyanate groups and the isocyanate-reactive polymer in such a manner that the crosslinking reaction gives rise to the desired crosslink density even after brief exposure to heat.

Without a catalyst, the crosslinking reaction in these storage-stable, latently reactive layers, films or powders proceeds so slowly that using this technology is not economically viable. Accordingly, a latently reactive film produced using the aliphatic IPDI trimer as the solid isocyanate must be kept at 120° C. for at least 30 minutes in order to achieve a sufficiently high crosslink density in the adhesive bond.

The catalysts listed in EP-A 0 922 720 (tin, iron, lead, cobalt, bismuth, antimony, zinc compounds or mixtures thereof, alkyl mercaptide compounds of dibutyltin and tertiary amines) are catalysts which are typically used for isocyanate reactions. Individually, however, these catalysts have disadvantages with regard to the use thereof in the production of latently reactive coatings, latently reactive films or latently reactive powders which make their use impossible.

Organic Zn (IV) compounds such as for example DBTL are accordingly generally contaminated with dibutyltin or tributlytin, as is known from “Assessment of the risk to health and environment posed by the use of organostannic compounds (excluding use as biocide in antifouling paints) and a description of the economic profile of the industry, Final report 19 Jul. 2002, European Commission Health & Consumer Protection Directorate General”. The use of Zn (IV) compounds is also not desirable from an environmental standpoint. Moreover, in addition to catalysing the isocyanate reaction, organic Zn (IV) compounds also catalyse the hydrolysis of the polyester segments of the polyester polyurethane polymer chain, as are used for the isocyanate-reactive dispersion polymers in latently reactive layers. It is for this reason that organic Zn (IV) compounds cannot be used for catalysing the reaction of surface-deactivated aliphatic solid isocyanates with crystalline isocyanate-reactive polyurethane dispersion polymers based on polyester polyol.

Furthermore, prior art catalysts generally only have a finite life in aqueous systems, i.e. the catalyst is hydrolysed more or less rapidly by exposure to water. This applies not only to the aqueous preparation of surface-deactivated aliphatic solid isocyanates and isocyanate-reactive dispersed polymers but also to the largely dry latently reactive coatings which generally still have a residual moisture content of approx. 0.6-1.0 wt. % water relative to the weight of the coating. This applies to a particularly marked extent to the tin (IV) compounds often used in conventional systems, such as DBTL or also to bismuth carboxylates such as for example bismuth (III) 2-ethylhexanoate; (K-Kat., King Industries, Norwalk, Conn., USA), as is also described in WO 00/047642.

Catalysts which are coloured or cause discoloration obviously cannot be used in colourless adhesive layers. Accordingly, the iron, cobalt or bismuth catalysts mentioned in EP-A 0 992 720 cannot be used for non-discolouring adhesive layers.

Lead and antimony compounds are likewise not advantageous due to their toxicological properties and environmental impact and should therefore in principle not be used.

A further problem for the catalysis of the reaction between surface-deactivated solid isocyanate and isocyanate-reactive dispersion polymer is the ionic groups which are required to hydrophilise the polymer chain of the dispersion polymer. Hydrophilisation may be achieved by carboxyl groups incorporated into the polymer chain. Under certain circumstances, these carboxyl groups may have a complexing action which inhibits the catalytic activity of organotin compounds. This applies to all highly charged Lewis acids, such as for example titanium (IV), zirconium (IV) compounds. A catalyst which is intended to be universally usable with numerous surface-deactivated aliphatic solid isocyanates, polyisocyanates and hydrophilised binders, must not exhibit these interactions with the hydrophilising agent.

EP-A 1 599 525 describes catalysts for the accelerated curing of polyisocyanates with polyols and polyurethane systems containing them.

The (poly)isocyanate components which may be used according to this teaching are any desired organic polyisocyanates with aliphatically, cycloaliphatically, araliphatically and/or aromatically attached, free isocyanate groups which are liquid at room temperature or are diluted for this purpose with solvent. The (poly)isocyanate component exhibits a viscosity of 10-15000 mPa·s at 23° C.

Specifically, the invention of EP-A 1 599 525 relates to catalysts for the accelerated curing of polyisocyanates with polyols in the presence of water as solvent (aqueous two-component polyurethane coating compositions, two-pack PU aqueous coating compositions). The object was to identify catalysts which accelerate the reaction between the isocyanate and the alcohol or the polyol in the presence of water or which accelerate curing of aqueous two-pack PU systems, without in so doing having an influence on pot life. This object was achieved by using various salts of elements from (sub)groups 5 and 6 of the periodic system of elements, in which the particular element has an oxidation number of at least +4.

In addition to the metal catalysts, EP-A 0 992 720 also mentions tertiary amines as effective catalysts. However, as has already been described in EP-A 0 992 720, tert.-amines become inactive by absorbing carbon dioxide from the air. This fact is particularly unwanted for latently reactive coatings, films or powders because it is precisely the storage stability of the coatings, films or powders also with regard to the rate of crosslinking which is indispensable for the use of the latently reactive layers.

### SUMMARY OF THE INVENTION

The object of the present invention was accordingly to provide preparations of aqueous dispersions or dispersion mixtures of isocyanate-reactive polymers and surface-deactivated aliphatic solid isocyanate particles and catalyst with which colourless and colour-stable, storage-stable latently reactive coatings, latently reactive films and latently reactive powders may be produced. The catalysts should also have a positive evaluation with regard to their toxicological properties. The crosslinking reaction in the coatings, films or powders should be achieved within an applicationally acceptable heat-activation time.

This object has been achieved by the present invention: it has surprisingly been found that compounds of elements from subgroups 5 and 6 of the periodic system of elements, in which the particular element has an oxidation number of at least +4, catalyze the reaction between surface-deactivated solid isocyanate and isocyanate-reactive polymer in such a manner that the crosslinking reaction proceeds at temperatures of ≦120° C. and is largely complete within at most 10 minutes. Moreover, use of the catalysts according to the invention ensures storage stability of the latently reactive coatings, films/nonwovens or powders of at least 3 months.

Preparations according to the invention are therefore mixtures of:
a) a substantially aqueous dispersion or dispersion mixture of at least one polymer having isocyanate-reactive groups
b) a surface-deactivated, finely divided aliphatic solid polyisocyanate at least suspended in water
c) at least one compound of elements from subgroups 5 and 6 of the periodic system of elements, in which the particular element has an oxidation number of at least +4 and
d) optionally further additives and auxiliaries.

### BRIEF DESCRIPTION OF THE DRAWINGS

The invention is further illustrated by the following non-limiting drawing in which:

FIG. 1 illustrates development of the storage modulus of two adhesive-films (Dispercoll® U 53 with Desmodur® Z XP 2589 (micronised IPDI trimer deactivated with 3 mol % amino groups)) during heat-activation at 120° C.

### DETAILED DESCRIPTION OF THE INVENTION

As used herein in the specification and claims, including as used in the examples and unless otherwise expressly specified, all numbers may be read as if prefaced by the word “about”, even if the term does not expressly appear. Also, any numerical range recited herein is intended to include all sub-ranges subsumed therein.

The latently reactive aqueous preparations according to the invention may be applied in any desired manner, for example by spraying, knife coating, brushing or roller application methods, onto flat or three-dimensional surfaces. After drying, latently reactive (preapplied) coatings are obtained.

They may also be applied onto release paper (for example silicone paper or paper with a nonstick polyolefin finish or similar backing materials) by spraying, knife coating, brushing, or roller application methods. After drying, self-supporting latently reactive films or nonwovens are obtained, which optionally after insertion of a release paper, may be wound and stored until use as an adhesive film.

Solids in the form of granules or powder may be obtained from the preparations according to the invention using suitable industrial methods.

For example, water may be removed from the formulations according to the invention by spray drying. In this manner, latently reactive powders are obtained which may optionally be ground to small particle sizes by a subsequent grinding process.

Latently reactive powders may also be obtained by coagulating polymer dispersions with surface-deactivated solid isocyanate particles. Mixtures of, for example, anionically stabilised polymer dispersions and surface-deactivated solid isocyanate are here dispersed by means of a rotor/stator mixer (for example from Kotthoff) or by means of a jet disperser in a salt solution comprising polyvalent cations (for example Ca²⁺, Mg²⁺, Al³⁺). When the anionic groups on the surface of the polymer particles come into contact with the polyvalent cations, the polymer particles immediately coagulate, the surface-deactivated solid isocyanate particles being enclosed in the coagulate. Water is largely removed from the coagulate by filtration, centrifugation etc. and the coagulate is then dried at temperatures of below the reaction temperature of the deactivated aliphatic solid isocyanate. After drying, the coagulate may optionally be ground to the required particle sizes in a grinding process, for example in ball, bead or sand mills or jet mills.

Another possibility for producing latently reactive powders involves removing the mixture of polymer and surface-deactivated solid isocyanate from the aqueous preparations by freezing at temperatures of below 0° C. Water is then largely removed from the precipitated polymer/isocyanate mixture by filtration, centrifugation etc. and the precipitated mixture is then dried. The resultant coarse-grained powder may then be ground to the required particle sizes, for example in ball, bead or sand mills or jet mills, by a suitable grinding method, the grinding process optionally having to proceed at low temperatures.

Drying of the latently reactive coatings, films, nonwovens or powders must proceed at temperatures below the softening temperature of the polymer or the melting or softening temperature of the surface-deactivated aliphatic solid isocyanate. Whichever is the lowest of the softening or melting temperatures must be used for this purpose. If one of the stated temperatures is exceeded, the polymer will inevitably crosslink. The largely dry latently reactive coatings, films or powders still have a residual moisture content of 0.1-5%.

The aqueous dispersions for the preparations according to the invention preferably contain polyurethane or polyurea dispersions having crystalline polyester soft segments as the isocyanate-reactive dispersion polymer. Particularly preferred dispersions are those of isocyanate-reactive polyurethane polymers comprising crystalline polymer chains which, when measured by thermomechanical analysis, at least partially decrystallise at temperatures of between 50° C. and 120° C.

Solid isocyanates are any aliphatic and cycloaliphatic di- and polyisocyanates having a softening temperature of ≧40° C. In particular, dimerisation and trimerisation products of isophorone diisocyanate (Desmodur® I, Bayer MaterialScience AG, Leverkusen), bis-(4-isocyanatocyclohexyl)-methane (Desmodur® W, Bayer MaterialScience AG, Leverkusen), ω,ω′-diisocyanato-1,3-dimethylcyclohexane (H6XDI) and mixtures of these dimerisation and trimerisation products and cotrimerisation products of Desmodur® I/Desmodurg® W, Desmodur® I/Desmodur® H (Desmodur® H=hexamethylene diisocyanate), Desmodur® W/Desmodur® H, Desmodur W/H6XDI, Desmodur® I/H6XDI may be used according to the invention.

Prior to use, the aliphatic solid isocyanates according to the invention must be ground by a suitable grinding method for example in ball, bead, sand mills, disk mills or jet mills to particle sizes d50<100 μm, preferably d50<10 μm and particularly preferably d50<2 μm.

The suspended surface-deactivated isocyanates may be produced according to the methods known from EP-A 0 992 720 and EP-A 1 172 390.

Catalysts which may be used according to the invention are in general chemical compounds of elements from subgroups 5 and 6 of the periodic system of elements, in which the particular element has an oxidation number of at least +4. Salts of these elements in which the elements have the stated oxidation number are preferably used. Compounds of the elements vanadium, niobium, tantalum, molybdenum and tungsten have in particular proved suitable and are therefore preferably used. Such compounds of the elements vanadium, tantalum, molybdenum and tungsten are for example salts of molybdic acid, such as the alkali metal salts of molybdic acid and the alkali metal salts of vanadic acid as well as tetraethylphosphonium molybdate, magnesium molybdate, calcium molybdate, zinc molybdate, lithium tungstate, potassium tungstate, tungstic acid, ammonium tungstate, phosphotungstic acid, sodium niobate and sodium tantalate. The alkali metal salts of vanadium and of molybdenum are particularly preferred.

The quantities of catalyst used are, relative to the dried (preapplied) coating, dried film or dried powder, from 10-50000 ppm, the activity of the catalyst not being dependent on the nature of addition. This means that the catalyst may be added
to the aqueous polymer dispersions
during production of the surface-deactivation of the aliphatic solid isocyanate, or
to the formulation consisting of polymer dispersion, surface-deactivated solid isocyanate and optionally further additives and auxiliary substances.

In addition to providing effective catalysis, the catalysts used according to the invention are also distinguished by a certain latency phase (delayed onset of catalytic action) during heat-activation. This effect, which is advantageous for latently reactive (preapplied) coatings, films, nonwovens or powders ensures that the catalyst cannot have any effect on the storage stability of the latently reactive layers, films, nonwovens or powders.

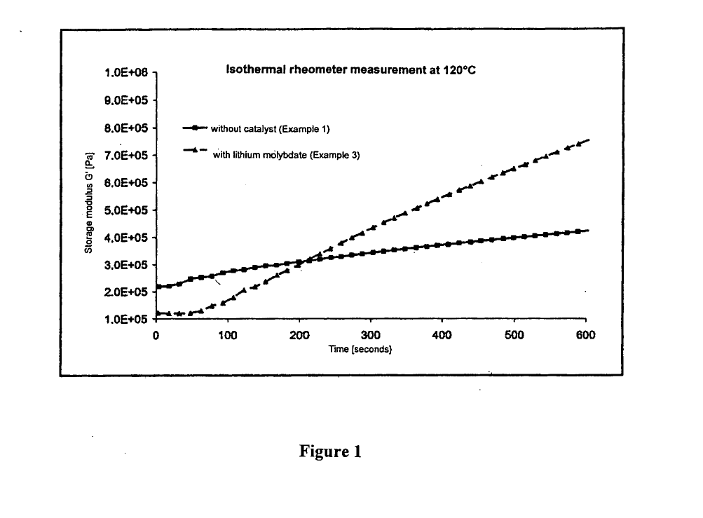

The diagram in FIG. 1 shows this phenomenon by way of example with reference to the development of the storage modulus of two adhesive films (Dispercollφ U 53 with Desmodur® Z XP 2589 (micronised IPDI trimer deactivated with 3 mol % amino groups)) during heat-activation at 120° C. In the case of the latently reactive adhesive film without catalyst (produced from dispersion 1, Comparative Example), the storage modulus start to increase immediately when heat-activation begins. The latently reactive adhesive film catalysed with lithium molybdate (produced from dispersion 3, Example according to the invention) initially exhibits no change in storage modulus under the same conditions. The catalytic action of the lithium molybdate only becomes evident after approx. 50 seconds. The storage modulus then increases distinctly more rapidly than it does in the latently reactive adhesive film without catalyst.

In the latently reactive (preapplied) coatings, films, nonwovens or powders produced from the preparations according to the invention, the crosslinking reaction is initiated by input of heat. The preapplied coating, film, nonwoven or powder must be heated either to a temperature above the decrystallisation temperature of the polymer or to a temperature above the softening temperature of the deactivated aliphatic solid isocyanate (melting temperature or glass transition temperature).

### Adhesive Application/Joining Method:

The (preapplied) coating, adhesive film, adhesive nonwoven or adhesive powder may be applied, laid or spread onto one surface of the substrates to be joined (one-sided application) or onto both of the substrate surfaces to be joined (two-sided application). The procedure (one- or two-sided application) which is ideal for the particular intended use is here inter alia dependent on the wetting characteristics of the substrate surfaces during heat-activation with the thermoplastically softened adhesive layer and may straightforwardly be determined as a routine task by a person skilled in the art in this technical field.

The following methods are in principle available for producing the adhesive joint:
1. Brief heat-activation of the adhesive layer and initiation of the crosslinking reaction:
   The latently reactive coating, latently reactive film, latently reactive nonwoven or latently reactive powder are heated to a temperature above the decrystallisation temperature of the polymer or the softening temperature of the solid isocyanate by brief heat-activation, for example in a heating channel, by means of IR radiation or by microwave irradiation.
   Immediately thereafter, the substrate surfaces are joined together under pressure. In this case, the crosslinking reaction is merely started by the brief heat-activation. The final properties of the crosslinked adhesive layer are achieved after 1-5 days.
   The advantage of this procedure resides in the short processing step for the joining operation and the relatively low temperatures during heat-activation. This is of particular interest when thermally sensitive substrates are to be adhesively bonded.
2. Heat-activation of longer duration until the final properties of the adhesive joint are achieved:
   The latently reactive coating, latently reactive film, latently reactive nonwoven or latently reactive powder are located between the substrates to be adhesively bonded. The substrates are pressed for a relatively extended period at a temperature above the decrystallisation temperature of the polymer or above the softening temperature of the aliphatic solid isocyanate. In this manner, the final properties of the adhesive joint may be achieved immediately after the joining process.
   The advantage of this procedure resides in the possibility of rapid further processing of the adhesive joint or the possibility of carrying out quality testing immediately after the joining process.
3. Combination of brief heat-activation, for example for fixing the parts to be joined, and longer heat-activation for final crosslinking.
The advantage this procedure resides in the possibility of joining the substrates to one another in a short joining process. Final crosslinking then proceeds in a second step, which may be carried out separately from the first joining process at both different times and places.

### EXAMPLES

### Raw Materials

Isocyanate-reactive polymer dispersion
   Dispercoll® U 53,polyurethane dispersion from Bayer MaterialScience AG, 51368 Leverkusen; solids content approx. 40 wt. %.; isocyanate-reactive polymer comprising linear polyurethane chains based on an adipic acid/butanediol polyester with HDI/IPDI as the isocyanate component. The polymer crystallises once the dispersion has dried and the film has cooled to 23° C. When measured by means of thermomechanical analysis, the film is largely decrystallised at temperatures of ≧+65° C.
Aliphatic solid isocyanate
   Desmodurg® Z XP 2589; micronised IPDI trimer; manufacturer: Bayer MaterialScience AG, 51368 Leverkusen; NCO content approx. 17%, particle size d50 approx. 1.5 μm, Tg approx. 65° C.
Deactivation amine
   Jeffamine® T 403; trifunctional polyether amine, MW=approx. 450, manufacturer: Huntsman Corp., Utah, USA.

Auxiliary substances:
Tamol® NN 4501 (45% in water) protective colloid; manufacturer: BASF AG, 67056 Ludwigshafen
Borchigel® ALA; thickener; manufacturer: Borchers GmbH, D-40765 Monheim.
Emulsifier FD, nonionic emulsifier, manufacturer: Lanxess AG, Leverkusen
Formulations of the surface-deactivated solid isocyanates (crosslinking agents):

### Comparative Examples (crosslinking agents 1 and 2)

Deionised water, emulsifiers, deactivation amine, thickener and solid isocyanate are initially introduced and mixed with a dissolver disk at 2000 rpm within 15 minutes to yield a homogeneous suspension.

### Examples according to the invention (crosslinking agents 3-6)

The catalyst is first of all dissolved in deionised water. Then, the emulsifiers, the deactivation amine, the thickener and the solid isocyanate are added and mixed with a dissolver disk at 2000 rpm within 15 minutes to yield a homogeneous suspension.

| | | Crosslinking | Crosslinking | | | | |
|---|---|---|---|---|---|---|---|
| | | agent 1 | agent 2 | Crosslinking | Crosslinking | Crosslinking | Crosslinking |
| | | (comparison) | (comparison) | agent 3 | agent 4 | agent 5 | agent 6 |
| Raw material | Function | Parts by weight | | | | | |
| Deionised water | medium | 100 | 100 | 100 | 100 | — | 100 |
| Aqueous solution with | medium with catalyst | — | — | — | | 100 | — |
| 1000 ppm zinc vanadate | | | | | | | |
| Lithium molybdate | catalyst | — | — | 3.36 | 3.36 | — | — |
| Lithium orthovanadate | catalyst | — | — | — | — | — | 3.36 |
| Tamol ® NN 4501 | protective colloid | 0.7 | 0.7 | 0.7 | 0.7 | 0.7 | 0.7 |
| Emulsifier FD | emulsifier | 0.08 | 0.08 | 0.08 | 0.08 | 0.08 | 0.08 |
| Jeffamine ® T 403 | deactivation amine | 1.3 | 3.1 | 1.3 | 3.1 | 3.1 | 3.1 |
| BorchiGel ® ALA | thickener | 10 | 10 | 10 | 10 | 10 | 10 |
| Desmodur ®Z XP 2589 | solid isocyanate | 67 | 67 | 67 | 67 | 67 | 67 |

In order to deactivate the solid isocyanate, crosslinking agents 1 and 3 contain 3 mol % of amino groups relative to all available NCO groups of the IPDI trimer.

The IPDI trimer of formulations 2, 4, 5 and 6 was deactivated with 7 mol % of amino groups relative to the available NCO groups of the IPDI trimer.

Polymer Dispersions with Surface-Deactivated Solid Isocyanate Particles:

The polymer dispersions are initially introduced. The formulations of the surface-deactivated solid isocyanates are stirred in.

| | | | Parts by |
|---|---|---|---|
| | Raw material | Function | weight |
| Dispersion 1 | Dispercoll ® U 53 | polymer dispersion | 100 |
| (comparison) | Crosslinking agent 1 | solid isocyanate | 20 |
| | | suspension | |
| Dispersion 2 | Dispercoll ®U 53 | polymer dispersion | 100 |
| (comparison) | Crosslinking agent 2 | solid isocyanate | 20 |
| | | suspension | |
| Dispersion 3 | Dispercoll ®U53 | polymer dispersion | 100 |
| | Crosslinking agent 3 | solid isocyanate | 20 |
| | | suspension | |
| Dispersion 4 | Dispercoll U ® 53 | polymer dispersion | 100 |
| | Crosslinking agent 4 | solid isocyanate | 20 |
| | | suspension | |
| Dispersion 5 | Dispercoll ® U 53 | polymer dispersion | 100 |
| | Crosslinking agent 5 | solid isocyanate | 20 |
| | | suspension | |
| Dispersion 6 | Dispercoll ® U 53 | polymer dispersion | 100 |
| | Crosslinking agent 6 | solid isocyanate | 20 |
| | | suspension | |

Dispersions 1 and 2 are Comparative Examples without catalyst. Examples 3 to 6 are according to the invention.

### Testing of the Action of the Catalysts on the Reactivity of a Latently Reactive Preapplied Coating:

The polymer dispersions of Examples 1-6 were applied with a 200 μm knife coater onto beechwood test specimens (dimensions of test specimens: 50 mm×140 mm; 4 mm thick) over an area of 50 mm×110 mm and dried for 1 hour at 23° C. After a further 3 hours, a PVC film (supplier: Benecke) was laminated onto the adhesive layer at 80° C. and 100° C. (press temperature) and 4 bar pressure for 5 minutes, 10 minutes, 15 minutes, 30 minutes and 60 minutes. Immediately after removal of the beechwood/PVC bonded laminate from the press, the bonds were suspended in a heated cabinet adjusted to 80° C. and heat-treated for 3 minutes. A 2.5 kg weight was in each case attached to a PVC film and the adhesive joint was loaded for a period of 5 minutes under peel test conditions (angle of 180°) at 80° C.

The length peeled over a test period of 5 minutes may be used as an indicator of the crosslinking reaction. The peeled length is converted into mm/minute. The smaller the value, the faster the crosslinking reaction or the more active the catalyst.

| | Peeled length [mm/minute] | | | | | |
|---|---|---|---|---|---|---|
| Press temperature, | Dispersion 1 | Dispersion 2 | | | | |
| 80° C. | (comparison) | (comparison) | Dispersion 3 | Dispersion 4 | Dispersion 5 | Dispersion 6 |
| 5 minutes | >20 | >20 | >20 | >20 | 8 | 12 |
| 10 minutes | >20 | >20 | >20 | 8 | 7 | 7 |
| 15 minutes | >20 | >20 | >20 | 6 | 7 | 6 |
| 30 minutes | >20 | >20 | 1 | 1 | 4 | 1 |
| 60 minutes | 10 | 8 | — | — | — | — |

| | Peeled length [mm/minute] | | | | | |
|---|---|---|---|---|---|---|
| Press temperature, | Dispersion 1 | Dispersion 2 | | | | |
| 100° C. | (comparison) | (comparison) | Dispersion 3 | Dispersion 4 | Dispersion 5 | Dispersion 6 |
| 5 minutes | >20 | >20 | >20 | >20 | 6 | 10 |
| 10 minutes | >20 | >20 | 1 | 1 | 4 | 1 |
| 15 minutes | >20 | 18 | — | — | — | — |
| 30 minutes | 15 | 1 | — | — | — | — |
| 60 minutes | 1 | — | — | — | — | — |

Assessment: the catalysts lithium molybdate, zinc molybdate and lithium orthovanadate accelerate crosslinking in latently reactive preapplied coatings. Dispersions 3-6 according to the invention are already crosslinked after 30 minutes at a press temperature of 80° C. (comparison dispersions 1 and 2=>60 minutes) and after <10 minutes at a press temperature of 100° C. (comparison dispersions 1 and 2=>15 min).

(Note: At a value of <5 mm/minute, the adhesive layer is deemed to be crosslinked; “-” means that further measurements are not meaningful)

### Action of the Catalysts in Latently Reactive Adhesive Powders:

Production of Latently Reactive Powders:

Dispersions 2 (comparison) and 4 (according to the invention) were stored in a freezer for 24 hours at −5° C., the polymer precipitating out in the form of coarse solid particles. The formulation was heated to room temperature and the precipitated polymer was separated from the serum by filtration. The polymer was then dried under mild conditions and ground to a particle size of d50 approx. 100 μm in a jet mill with cooling.

Testing:

2.4 g of the powder were spread uniformly over an area of 14 cm×24 cm of cotton/polyester blend fabric (corresponding to approx. 70 g/m²). The cotton/polyester blend fabric was then pressed against an uncoated polyester fabric for 2 minutes in a membrane press at a press temperature of 80° C. and a pressure of 1 bar. The adhesive joint was stored for 24 hours in a standard atmosphere (23° C., 50% relative humidity) and then subjected to creep testing.

Creep Testing:

For the purposes of creep testing, the bonded textiles were suspended, initially without weight loading, in a heated cabinet adjusted to 60° C. and heat-treated for 30 minutes. The adhesive joints (180° peel test) were then loaded with a 50 g weight and left for a further 30 minutes at 60° C. Once 30 minutes' testing had elapsed, the peeled length [mm] was determined. Every 30 minutes thereafter, the temperature was increased by 10° C. The peeled length was determined once each temperature stage had elapsed.

| | Peeled length [mm]/temperature stage | |
|---|---|---|
| Test | Powder from dispersion 2 | Powder from dispersion 4 |
| temperature | (comparison) | (according to the invention) |
| 60° C. | 2 | 0 |
| 70° C. | 5 | 0 |
| 80° C. | 10 | 0 |
| 90° C. | 13 | 0 |
| 100° C. | completely peeled off | 0 |
| 110° C. | — | 0 |
| 120° C. | — | 0 |
| 130° C. | — | 0 |
| 140° C. | — | 0 |
| 150° C. | — | 0 |

Acceleration of the crosslinking of the latently reactive powder with lithium molybdate is here revealed by the short peeled length up to a temperature of 150° C. The adhesive joint with the powder without lithium molybdate has come completely apart at a temperature of just 100° C.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Aqueous compositions containing
a) dispersed polymers with isocyanate-reactive groups
b) at least one surface-deactivated aliphatic solid polyisocyanate suspended in water, with a softening temperature of ≧40° C.,
c) one or more compounds of elements from subgroups 5 and 6 of the periodic system of elements, in which the particular element has an oxidation number of at least +4 and,
d) optionally further additives and auxiliaries.

2. A composition according to claim 1, wherein the dispersed isocyanate-reactive polymer contains urethane and urea groups.

3. A composition according to claim 1, wherein the isocyanate-reactive polymer has crystallising polymer units.

4. A composition according to claim 1, wherein the isocyanate-reactive polymer has crystallising polyester soft segments as the crystallising polymer units.

5. A composition according to claim 1, wherein the aliphatic solid isocyanates exhibit a particle size of d50<100 μm.

6. A composition according to claim 1, wherein the aliphatic solid isocyanates exhibit a particle size of d50<2 μm.

7. A composition according to claim 1, wherein the aliphatic solid isocyanate is IPDI trimer.

8. A composition according to claim 1, wherein at least one compound of the elements molybdenum and vanadium is used as component (c).

9. A composition according to claim 1, wherein at least one compound of the element molybdenum is used as component (c).

10. A composition according to claim 1, wherein lithium molybdate is used as component (c).

11. A method for producing compositions according to claim 1, wherein component (c) is premixed in the aqueous phase of the dispersed polymer (a).

12. A method for producing compositions according to claim 1, wherein component (c) is premixed in the formulation of the aliphatic solid isocyanate (b).

13. A method for producing compositions according to claim 1, wherein component (c) is premixed in further additives and auxiliary substances (d).

14. A method for producing compositions according to claim 1, wherein component (c) is added to the aqueous phase of the formulation consisting of the dispersed polymer (a), the surface-deactivated aliphatic solid isocyanate (b) and optionally added additives and auxiliary substances.

15. A method for producing latently reactive coatings from the compositions according to claim 1, wherein the compositions are applied onto substrate surfaces and are dried.

16. A method for producing backing-free latently reactive films or nonwovens from the compositions according to claim 1, wherein the compositions are applied onto release paper, dried and removed from the release paper.

17. A method for producing latently reactive powders from the compositions according to claim 1, wherein the solid constituents of the formulations are precipitated and separated, or are obtained by drying the aqueous dispersion and, optionally, are then micronised.

18. An adhesive comprising the compositions according to claim 1.

19. Backing-free films and nonwovens comprising the compositions of claim 1.

20. Adhesive powders comprising the compositions of claim 1.

21. Substrates adhesively bonded by compositions according to claim 1.
